(19) United States
(12) Patent Application Publication
(10) Pub. No.: US 2009/0083327 A1
(43) Pub. Date: Mar. 26, 2009

(54) Digital recipe box

(76) Inventors: Nicole A. Ringham, Temecula, CA (US); Carole K. Ringham, Temecula, CA (US)

Correspondence Address: NICOLE A. RINGHAM, 43282 MODENA DRIVE, TEMECULA, CA, 92592, US

(21) Appl. No.: 11/903,861

(22) Filed: Sep. 26, 2007

(51) Int. Cl. G06F 17/30

(52) U.S. Cl. 707/104.1; 700/90; 707/E17.082

(57) ABSTRACT

A digital recipe box is disclosed that allows the user to get rid of big bulky recipe books, save space, eliminate the trips to the computer or having your computer in the kitchen and essentially saving time with the added bonus of organizing all recipes and protection of heirloom recipes. Additional features include a weekly/monthly menu to solve the question of what's for dinner. The menu planner includes a grocery list generator. When the grocery list is selected all ingredients necessary to prepare the meal are identified. The grocery list is downloaded to a computer, printed out saving time and additional trips to the grocery store. The device can be taken to a grocery store where it can link with a database in the grocery store to identify where the items to be purchased are located and can indicate the shortest path to all the items.

### FIELD OF THE INVENTION

This invention relates to an electronic recipe box. More particularly, the present electronic recipe box is a compact portable electronic cookbook that stores multiple known recipes and allows the user to enter additional recipes. The electronic recipe box is connectable to a computer and can generate a grocery list.

### BACKGROUND OF THE INVENTION

Most people have a number of recipe books. Some of these recipe books are passed down from relatives. Some people also keep recipes they find in a magazine, newspaper or are hand written. When preparing a meal from a cookbook a person opens the recipe book to determine the required ingredients, checks their inventory of ingredients and makes a list of the ingredients they don't have in stock. Some patents have issued on inventions that have tried to provide these features. Some exemplary examples are provided herein.

U.S. Pat. No. 6,789,067 issue Sep. 7, 2004 to Frank Liebenow discloses a computer program that merges multiple food preparation tasks and sorts them so the food prepared from all the tasks is complete at about the same time. While this patent covers the merging of multiple food preparation tasks with a database program of recipes and preparation steps it does not provide for entry of multiple recipes with grocery shopping list and menu planning.

U.S. Pat. No. 6,381,614 issue Apr. 30, 2002 to Jeffery R. Barnett et al., discloses an internet recipe database that integrates menus for food preparation of multiple dishes based on skill level. While the database provides for the storage of multiple recipes there is limited ability to enter personal recipes and the database does not prepare a shopping list.

U.S. Pat. No. 5,960,440 issued Sep. 28, 1999 to Richard Brenner et al., discloses a kitchen information and database management method and apparatus. The database includes recipes with a shopping list generator. While the data base can generate a shopping list the device is not portable, it does not automatically generate a daily, weekly or longer menu for food purchasing and preparation based upon eating preferences or frequently selected meals.

U.S. Published application 2001/0025279 published Sep. 27, 2001 to Lora Krulak et al., discloses a method and system for planning a customized menu. This system asks the user questions to determine their eating preferences. It then searches the internet and other databases to find three suggested matches. While the system discloses building an eating menu based upon the preferences of the user for one or more meals the system does not include grocery list generation and does not allow for a user to enter a new recipe.

What is needed is a device that has a built-in database of recipes as well as allowing a user to store their personal recipes. The recipe box would also generate a shopping list and include search tools, timing functions and track household inventories of ingredients. The proposed digital recipe box provides these functions in a compact portable electronic recipe box.

### BRIEF SUMMARY OF THE INVENTION

The purpose of the Digital Recipe Box is to allow the user to get rid of big bulky recipe books, save space, eliminate trips to the computer or having your computer in the kitchen and essentially saving time with the added bonus of organizing all recipes and protection of your heirloom recipes. Additional features include a weekly/monthly menu to solve the question of what's for dinner. The advantage to having the menu planner included is the next feature of a grocery list. For example you will put into your menu that for instance Monday you will be making baked chicken with rice and vegetables when you tab over to grocery list it will pull all ingredients necessary to prepare the meal. Once you input your menu you can easily use your USB cable to hook unit up to the computer and print out your grocery list. This feature alone will save you time and additional trips to the grocery store.

It is an object of the digital recipe box to store recipes in an electronic database that can be sorted where recipes can be grouped according to family member preferences, favorites, time to prepare and frequency of preparation. The database can be tied to an inventory of ingredients in the house and is capable of selecting only recipes where all the ingredients are in the house. The device can scale recipes based upon the number of people and convert the amount of ingredients from metric or English.

It is an object of the digital recipe box that allows for meal planning with suggestions based upon dietary need or calorie/fat/fiber indicator or a counter for the number of preparations each recipe. This aids the person preparing to the meals to provide a healthier meal and the digital recipe box can make suggestions for substitutions of items that will make the meal healthier.

It is an object of the digital recipe box to be a part of the kitchen decor by turning the digital recipe box into a digital clock, calendar, alarm or timer when it is not being directly used as a recipe box. The faceplate can be changeable to match the colors of the kitchen.

It is another object of the digital recipe box to allow the device to connect with home computers with a serial, USB, Bluetooth, LAN network or beaming of information. This allows the device to integrate with a home automation system or other internet connections such as a distal grocery store that will deliver the items desired.

It is still another object of the digital recipe box to integrate the recipes with the inventory of ingredients within the house and to produce a shopping list. The integration includes determinations of the expiration dates of items. Within a grocery store the box can communicate with a network within the grocery store and the device can map out the shortest path through the store to locate all the desired items.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows an isometric view of the digital recipe box.

FIG. 2 shows a flow chart of the operation of the digital recipe box.

FIG. 3 shows a flow chart of the features of data transfer into and out of the digital recipe box.

FIG. 4 shows a flow chart of the digital recipe box in operation with a grocery store.

FIG. 5 shows a flow chart for entering a recipe from an outside paper source.

FIG. 6 shows a preparation menu for cooking a meal.

### DETAILED DESCRIPTION

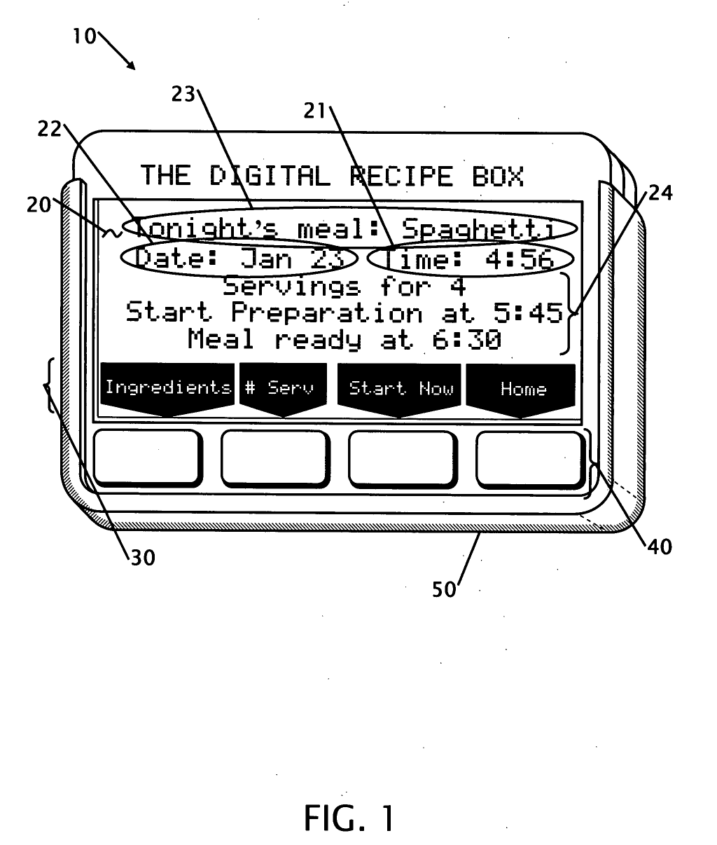

FIG. 1 shows an isometric view of the digital recipe box 10. The digital recipe box 10 is shown in a holder 50. The holder 50 allows the digital recipe box 10 to be mounted on a wall or a docking cradle when not being used or when data is being transferred into the digital recipe box 10. It is contemplated that the faceplate can be changeable to accommodate the decor of the room where the digital recipe box 10 is normally used. The digital recipe box 10 will be available in standard colors of black, white and silver but other colors are contemplated. It is also contemplated that the user can create or use a skin for the background of the display 20 to match the decor. In this figure the display shows text in the English language, but it is contemplated that the display can show different languages and can convert known words, text, and measurements from one language to another and from metric to English.

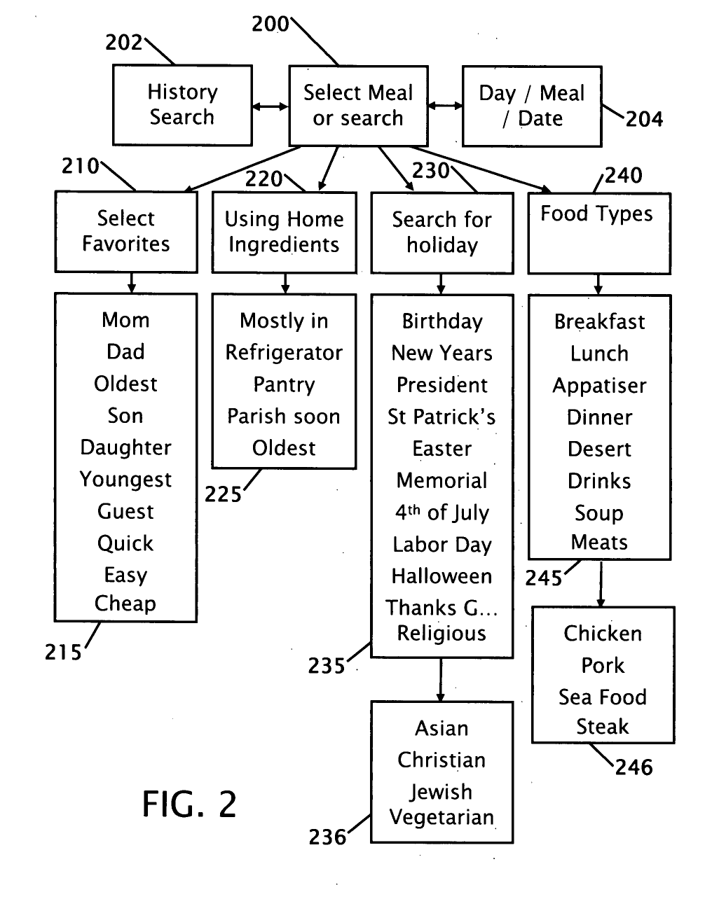

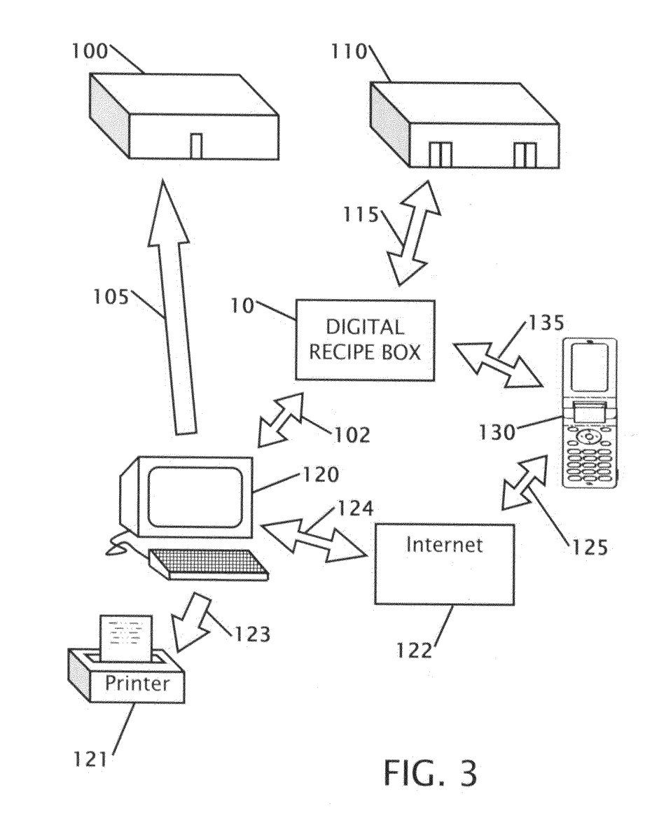

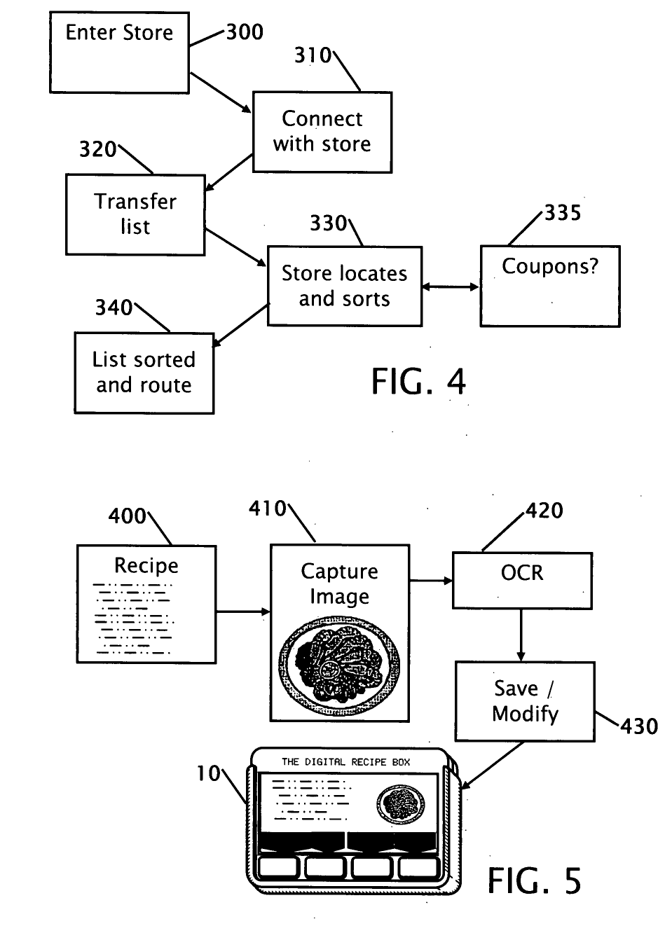

The digital recipe box 10 is preloaded with access to 1,000 of recipes, and allows the user to add additional recipes. The function of adding additional recipes is shown and described in more detail with FIGS. 3 and 5. The recipes are sortable in a variety of ways. The sorting is shown and described in more detail with FIG. 2. The digital recipe box 10 is compact and portable to allow the user to transport the digital recipe box 10 from one room to another as well as transport the digital recipe box 10 to a grocery store as shown and described in more detail in FIG. 4. The digital recipe box 10 is used to identify one or a number of meals for a period of one meal to multiple weeks of meals. The information regarding the required ingredients is sorted and the digital recipe box 10 generates a grocery list for the items. This is described in more detail with FIG. 3.

The display 20 of the digital recipe box 10 in FIG. 1 shows the next scheduled meal for the day 23, the date 22 and the time 21. The display shows additional information 24 to indicate the number people that will be served (4) at starting time for the meal (5:45) and when the meal is scheduled to be ready (6:30). If the number of people (4) is increased or decreased the amount of ingredients as well as the preparation time is automatically adjusted. While the display shows some specific information, it is contemplated that the layout on the screen is variable based upon customer selection and desire. On another contemplated embodiment the display 20 shows only the time of day in sufficiently large enough characters that the screen is filled. In another contemplated embodiment the display has a screen saver capability so a user can either download a picture or image. A series of options 30 allows the user the program, alter and selection a variety of items using the selection buttons 40. In this figure the four buttons allow the user to view the ingredients, change the number of servings, start the preparation now or at a future time, and return the display to home setting.

FIG. 2 shows a flow chart of the operation of the digital recipe box to select a menu of meals for the future. This flow chart begins with a meal search or selection tool 200. The selection process allows the user to quickly select a meal that was historically prepared 202 or select/enter a meal for a future day for preparation 204. The meals are organized and organizable into a variety of categories. The categories shown include, but are not limited to, Favorites 210, using home ingredients 220, searching by holiday 230 and by food types 240. A meal may appear in more than one category based upon the search criteria.

The day/meal date selection 204 in the digital recipe box is a simple to use menu planner. A user is able to plan your meals by the week or month which ever you choose. By using this feature, a user is able to print a menu off while connected to your PC and alleviate the nightly question of what's for dinner. For example this menu planner allows for a weekly menu of Sunday thru Saturday for week 1 and a monthly menu for weeks 2-4 or longer.

The select favorites 21 option allows the user to further identify what person in the family the meals is preferred by including but not limited to mom, dad, oldest, son, daughter, youngest, guest as well as sorting by a meal being quick to prepare, easy to prepare and cheap 215. It is also contemplated that the meals are searchable based upon calories, fat content, fiber content, dietary categories and similar cooking temperatures.

The using home ingredients 220 option will only display menu options where the ingredients are present in the house and a trip to a store is not required to complete the meal. Within this option the there are several selection choices based upon the ingredients, included but not limited to, being mostly found in the refrigerator, pantry, where the ingredients will parish soon or the ingredients are the oldest 225. Some items such as milk will have an expiration date of a week, while the expiration date of other items such as yeast could be several years.

The search for holiday 230 option allows the user to search for a menu item based upon a particular holiday including but not limited to, holidays such as birthday, New Years, President's day, St. Patrick's day, Easter, Memorial day, 4^{th} of July, Labor day, Halloween, Thanks Giving or for a particular religion or race 235 such as Asian, Christian, Jewish and vegetarian 236.

The food types 240 option allows a user to search by meal or food types most commonly identified as breakfast, lunch dinner, desert, drinks, soup, and meats 245. Meats are further categorized as groups such as chicken, pork, sea food and steak. In a search under chicken the digital recipe box it will pull all chicken recipes.

FIG. 3 shows a flow chart of the features of data transfer into and out of the digital recipe box 10. The digital recipe box 10 has a number of data transfer options. The options in this figure mostly represent how data is transferred out of the digital recipe box 10. Various data transfer methods are contemplated including but not limited to a connection 102 to a computer 120 using a cabled connection such as a USB, serial or parallel connection, a Bluetooth interface, WAN connection, a LAN connection, infrared beaming and 802.11b/g wireless interface. The connection 124 to the computer 120 allows for the transfer, loading and storing of recipes and cookbooks from eBooks, Betty Crocker cookbooks, Emeril Agassi cookbooks or other sites that offer electronic cookbooks. Since a computer usually has greater display and connection functions a user can manually enter, create and sort recipes categories that are stored on the digital recipe box 10.

The digital recipe box 10 sorts the future menu, compares the required ingredients with the ingredients within the house and generates a grocery list that can be printed 121 for use at a store. A user will be able to add items to the list with efficiency and ease. The digital recipe box adds commonly used items, such as milk, that will soon perish regardless of their identification from the recipe generation. Plug the unit into the computer using the USB cable and then check away at all items you may need as well. You will also be able to uncheck items that you may already have that the menu option has checked for you. Once completed the computer 120 sends 123 the list to a printer 121 to printout the list or the digital recipe box 10 can be taken to grocery store 110. FIG. 4 shows a flow chart of the digital recipe box 10 used in a grocery store. The computer 120 can send the shopping list 105 to a delivery store 100 for automatic ordering where the desired items are collected for delivery to the home. It is also contemplated that the digital recipe box 10 can communicate with the computer 120 where the information is sent over the internet 122 where the information is then sent 125 to the user's mobile or cellular device 130. Using Bluetooth or similar technology the digital recipe box 10 communicates 135 directly with a cellular device 130.

FIG. 4 shows a flow chart of the digital recipe box in operation with a grocery store. In this figure the digital recipe box is brought into a grocery store 300 and the digital recipe box is recognized by the grocery store using a wireless connection 310 such as Bluetooth, LAN, 802.11b/g or other wireless or wired connection. The shopping list within the digital recipe box is transferred 320 into the database of the grocery store where the location of the items is identified, sorted and a route 340 to all of the items is returned to the digital recipe box. This eliminates the need for a person to search for a particular item. The grocery store may additionally search for coupons 335 or alternative suggestions. The grocery store can also identify the purchasing habits of the user to offer equivalent ingredients. Once the ingredients are purchased the digital recipe box deducts the amount used from the purchased ingredients to track inventory levels of each ingredient. The digital recipe box uses common timelines for perishable items or a user can enter a particular expiration date.

FIG. 5 shows a flow chart for entering a recipe from an outside paper source. This figure starts with a paper recipe 400 from a book or hand written note. A user can transfer all their recipes into the digital recipe box. A user will no longer have to use your handwritten heirloom recipes. A user will be able to preserve handwritten recipes in their original state. The image 410 can be captured from a scanner or a digital camera on the digital recipe box 10. The digital recipe box uses optical character recognition 420 to convert the image of the recipe to text for storage. Any image of the complete recipe or hand written recipe is storable with the text of the recipe. The user has the option to alter and save 430 the recipe in the memory of the digital recipe box 10 for future use. The stored recipe can further be categorized in the digital recipe box 10 under personal recipes and personal favorites.

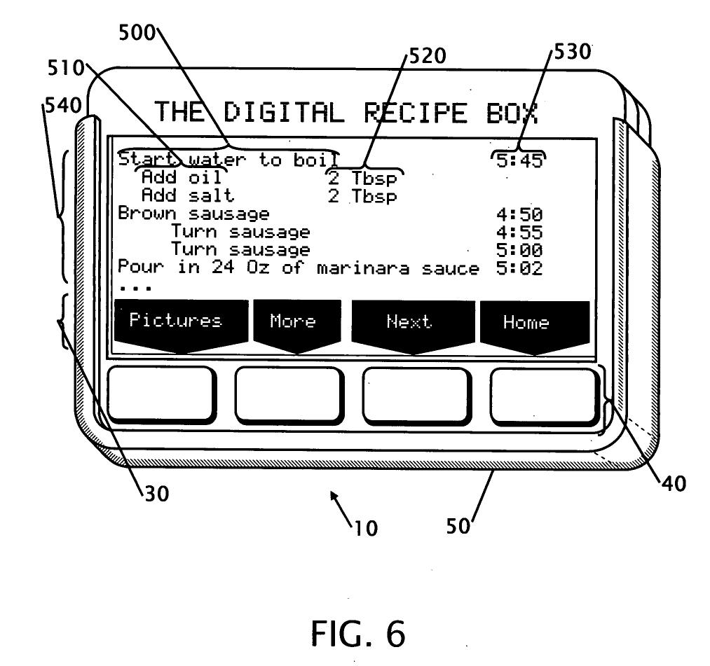

FIG. 6 shows a preparation menu for cooking a meal on the digital recipe box 10. The digital recipe box 10 is shown in the wall mount holder 50. The digital recipe box 10 includes an audible alarm to keep food preparation on a timed schedule. The timer(s) are included for meal prep of all foods to ensure they are ready at the same time. Having all aspects of a meal completed at the same time is at times an art. The digital recipe box 10 will have a timer included that will allow the user to time each dish. For example, when preparing chicken, mashed potatoes, green beans and rolls. The timer will let you know when you need to start each dish in order to have all ready at the same time.

In the display shown the meal is the spaghetti shown in FIG. 1. The display shows a series of the steps 540 that are need to be performed and in the order they need to be performed. The first step being shown is starting water to boil 500 at 5:45 530. Each ingredient 510 and the amount of each ingredient 520 are shown on the display. The menu options for the digital recipe box 10 are shown 30. If the user wants to see a picture of the step or of the complete meal they press the button under the “Pictures” button 40. If they want additional information on a step they press the button under “More”. When they have completed a step they press the button under “Next”. If the user wants to return to an initial screen on the digital recipe box 10 they select the button under “Home”. In the embodiment shown and described buttons are shown outside of the display screen but it is also contemplated that the digital recipe box 10 be made with a touch screen where a user presses the display to select or enter one or more items. This is particularly useful if a user need to enter a text string of information into the digital recipe box 10.

Thus, specific embodiments of a digital recipe box have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A digital recipe box comprising:
a portable electronic module with changeable face plates having a plurality of stored food preparation recipes;
additional storage means for entering and storing additional recipes;
periodic food menu creation and planning capability;
shopping grocery list generation, and
connection interface capability for uploading and downloading recipes and shopping grocery lists.

2. The digital recipe box according to claim 1 that further includes sorting and grouping of food preparation recipes.

3. The digital recipe box according to claim 2 wherein the sorting and grouping is by favorites, alphabetical, date of entry, food type, ingredients within the home, frequency of preparation, time to prepare, calories, fiber content and fat content.

4. The digital recipe box according to claim 3 wherein each recipe is scalable for more or less than the number of people the recipe was created for.

5. The digital recipe box according to claim 1 wherein the portable electronic module includes multiple languages and coverts recipes from one language to another language,

6. The digital recipe box according to claim 1 wherein the portable electronic module converts the amount of the ingredients needed to and from metric and English measurements.

7. The digital recipe box according to claim 1 wherein the portable electronic module has a face plate that is user changeable to accommodate a user preference.

8. The digital recipe box according to claim 1 wherein the portable electronic module includes one or more user selectable skins to accommodate a user's decorating preference.

9. The digital recipe box according to claim 1 that further includes a base, wall mount or docking station.

10. The digital recipe box according to claim 1 that further includes at least one timer for food preparation and to synchronize when different items are being prepared.

11. The digital recipe box according to claim 1 that further includes a communication interface to communicate with other devices including at least one of serial, parallel, USB, Bluetooth 802.11b/g, WLAN, LAN, infrared and cell phone communication.

12. The digital recipe box according to claim 11 wherein the communication links the digital recipe box with a grocery store to guide a user to the desired items in the shopping grocery list.

13. The digital recipe box according to claim 11 wherein the communication links the digital recipe box with a food delivery establishment to deliver items on the shopping grocery list.

14. The digital recipe box according to claim 11 wherein the communication link is with the user's computer or cell phone to create a grocery shopping list that the user can add to or modify.

15. The digital recipe box according to claim 1 wherein the portable electronic module tracks the purchase and expiration dates of perishable items and adds items to the shopping grocery list that have or will soon perish.

16. The digital recipe box according to claim 1 wherein the items on the shopping grocery list are sorted alphabetically, by cooking time, by cooking temperature, by cost, by expiration date, by product type, and days since the meal was last of preparation.

17. The digital recipe box according to claim 1 that can identify a food menu based upon the ingredients that are present in the house or with the minimum number of items to purchase.

18. The digital recipe box according to claim 1 wherein the periodic food menu creation and planning capability is for one meal to a years worth of meals.

19. The digital recipe box according to claim 1 wherein the display of the digital recipe box is not being used to as a recipe box the display shows a clock, a calendar or a timer.

20. The digital recipe box according to claim 1 that further includes a digital camera or scanner with character recognitions software to import a recipe and an image of the prepared food or the preparation steps into the additional storage means.
